(19) United States
(12) Patent Application Publication
(10) Pub. No.: US 2012/0012771 A1
(43) Pub. Date: Jan. 19, 2012

(54) Ball seat having collapsible helical seat

(76) Inventors: Lale Korkmaz, Houston, TX (US); Michael H. Johnson, Katy, TX (US); André J. Porter, Houston, TX (US)

(21) Appl. No.: 12/804,252

(22) Filed: Jul. 16, 2010

(51) Int. Cl. F16K 5/06

(52) U.S. Cl. 251/315.07

(57) ABSTRACT

Apparatuses for restricting fluid flow through a well conduit comprise a tubular member having a helically-shaped seat member disposed within the tubular member. The helically-shaped seat member comprises first and second ends, a first position in which the first and second ends relative to each other to provide a first diameter opening through the helically-shaped seat member for receiving a plug element, and a second position in which the second end is disposed axially below and radially outward relative to the first end to provide a second diameter opening through the helically seat member, the second diameter being greater than the first diameter thereby facilitating the plug element passing through the helically-shaped seat.

### BACKGROUND

1. Field of Invention

The present invention is directed to ball seats for use in oil and gas wells and, in particular, to ball seats having a movable helically-shaped seat that, when the helix is in one position, provides a seal for a ball disposed on the seat and, when in a second position, allows the ball to pass through the seat.

2. Description of Art

Ball seats are generally known in the art. For example, typical ball seats have a bore or passageway that is restricted by a seat. The ball or plug element is disposed on the seat, preventing or restricting fluid from flowing through the bore of the ball seat and, thus, isolating the tubing or conduit section in which the ball seat is disposed. As force is applied to the ball or drop plug, the conduit can be pressurized for tubing testing or tool actuation or manipulation, such as in setting a packer. Ball seats are also used in cased hole completions, liner hangers, flow diverters, frac systems, and flow control equipment and systems.

Although the terms “ball seat” and “ball” are used herein, it is to be understood that a drop plug or other shaped plugging device or element may be used with the “ball seats” disclosed and discussed herein. For simplicity it is to be understood that the term “ball” includes and encompasses all shapes and sizes of plugs, balls, darts, or drop plugs unless the specific shape or design of the “ball” is expressly discussed.

### SUMMARY OF INVENTION

Broadly, the ball seats disclosed herein comprise having a housing and a helically-shaped seat member disposed therein. A ball or plug element is disposed on the helically-shaped seat member to block or restrict flow through the housing. Subsequently, the ball is forced through the helically-shaped seat member by moving the helically-shaped seat member from a first position to a second position. The second position provides a diameter opening that is greater than the diameter opening of the helically-shaped seat member in its first position.

In general, the helically-shaped seat member comprises first and second ends that are disposed close to one another when in the first position. In one specific embodiment, first and second ends contact and overlap each other when in the first position. In another specific embodiment, the first and second ends are moved away from each other axially and radially when in the second position. In this embodiment, movement of the first end and second end away from each other causes the diameter opening through the helically-shaped seat member to increase so that the plug element can be passed through the helically-shaped seat member.

In certain embodiments, the helically-shaped seat member is operatively associated with a sliding sleeve disposed within the housing. In other embodiments the helically-shaped seat member is rotated during movement from its first position to its second position and vice versa. In still other embodiments, a return member moves the helically-shaped seat member from the second position back to the first position so that the ball seat can be reused.

In addition, the helically-shaped seat member can be moved to its second position to permit unrestricted passage of fluids and tool assemblies through the helically-shaped seat member or to create a ball seat or sealing point for downhole operations. Moreover, two ball seats each having a helically-shaped seat member can be disposed in series with each other, with a ball disposed between the two helically-shaped seat members so that the ball can function as a valve permitting and restricting fluid flow from above and from below the ball. Alternatively, the helically-shaped seat member can comprise a plurality of coils having an hourglass cross-sectional shape which can function as a valve.

### BRIEF DESCRIPTION OF DRAWINGS

FIG. 1 is a cross-sectional view of a specific embodiment of a ball seat disclosed herein shown with the helically-shaped seat member (shown in partial cross-sectional view) disposed in its collapsed position.

FIG. 2 is a cross-sectional view of the ball seat shown in FIG. 1 shown with the helically-shaped seat member (shown in partial cross-sectional view) in its expanded position so that the plug element can pass through the helically-shaped seat member.

FIG. 3A is a side view of the helically-shaped seat member of the ball seat shown in FIGS. 1-2 shown in the collapsed position.

FIG. 3B is a top view of the helically-shaped seat member of the ball seat shown in FIGS. 1-2 shown in the collapsed position.

FIG. 4A is a side view of the helically-shaped seat member of the ball seat shown in FIGS. 1-2 shown in the expanded position.

FIG. 4B is a top view of the helically-shaped seat member of the ball seat shown in FIGS. 1-2 shown in the expanded position.

FIG. 5 is a perspective view of the sleeve of the ball seat shown in FIGS. 1-2.

FIG. 6 is a partial cross-sectional view of the housing of the ball seat shown in FIGS. 1-2.

FIG. 7 is a cross-sectional view of another specific embodiment of a ball seat disclosed herein shown with the helically-shaped seat member disposed in its collapsed position.

FIG. 8 is a cross-sectional view of the ball seat shown in FIG. 7 shown with the helically-shaped seat member (shown in perspective view) in its expanded position so that the plug element can pass through the helically-shaped seat member.

FIG. 9 is a cross-sectional view of an additional specific embodiment of a ball seat disclosed herein shown with the helically-shaped seat member disposed in its collapsed position.

FIG. 10 is a cross-sectional view of the ball seat shown in FIG. 9 shown with the helically-shaped seat member in its expanded position so that the plug element can pass through the helically-shaped seat member.

FIG. 11 is a partial cross-sectional view of the housing of the ball seat shown in FIGS. 9-10.

FIG. 12 is a cross-sectional view of the ball seat shown in FIGS. 9-10 shown with the helically-shaped seat member returned to its collapsed with the plug element disposed below the helically-shaped seat member.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

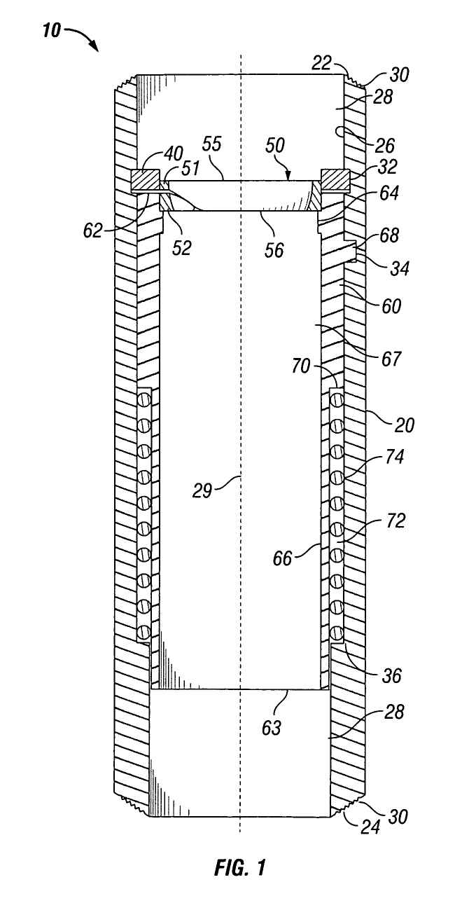

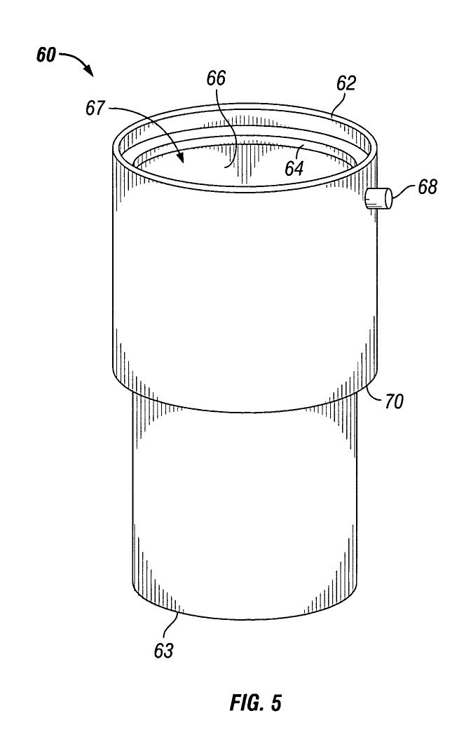

Referring now to FIGS. 1-6, in one embodiment, ball seat 10 includes a tubular member or housing 20 having upper end 22, lower end 24, and bore 28 defined by inner wall surface 26 and having axis 29. Attachment members such as threads 30 can be disposed along the outer wall surface of housing 20 at upper and lower ends 22, 24 of housing 20 for securing ball seat 10 into a string of conduit, such as drill pipe or tubing. Alternatively, attachment members such as threads 30 can be disposed along inner wall surface 26 of bore 28 at the upper and lower ends 22, 24 of housing 20 (not shown) for securing ball seat 10 into a string of conduit, such as drill pipe or tubing.

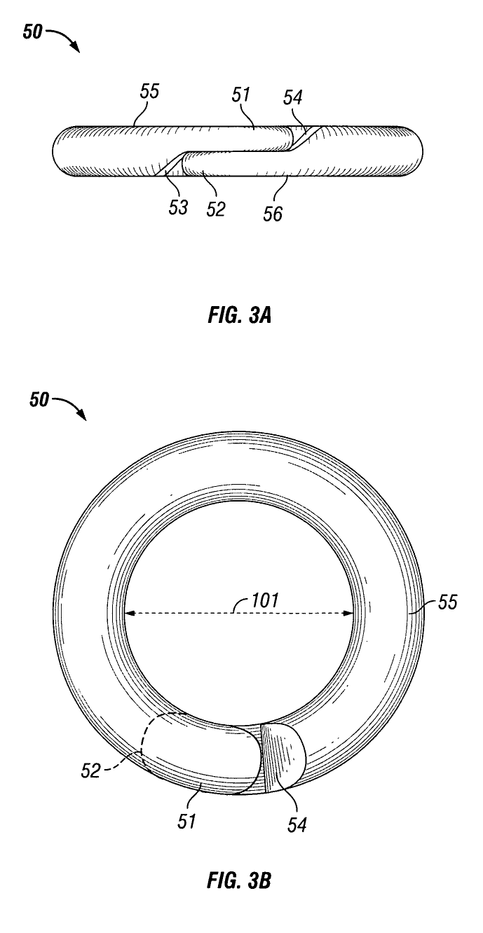

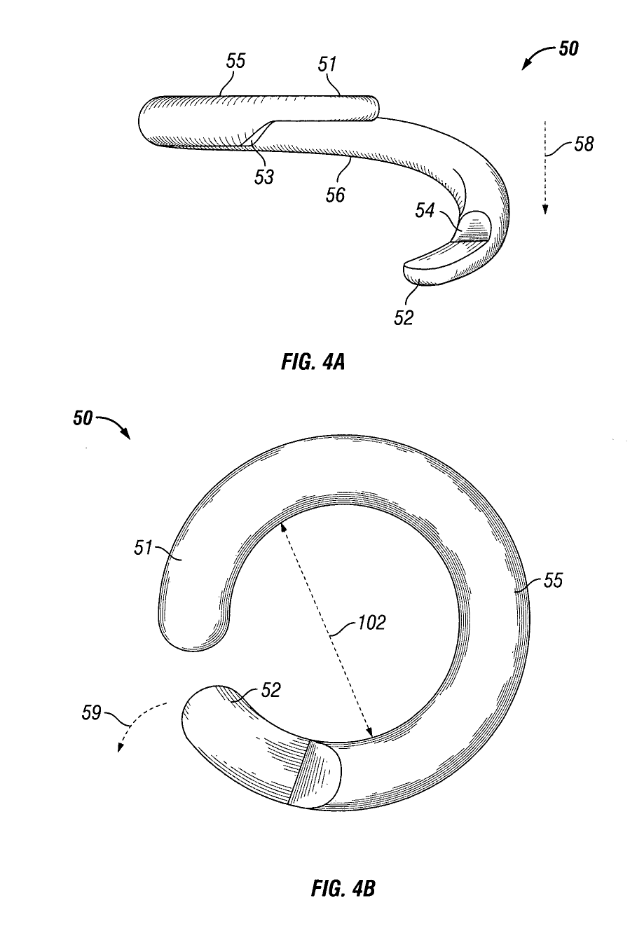

Disposed in bore 28 is helically-shaped seat member 50. As shown in greater detail in FIGS. 3-4, helically-shaped seat member 50 comprises first end 51, second end 52, upper surface 55, and lower surface 56. First end profile 53 is disposed on lower surface 56 toward first end 51 and second end profile 54 is disposed on upper surface 55 toward second end 52. First end profile 53 and second end profile 54 can have any shape desired or necessary to facilitate first and second ends 51, 52 to be placed in the collapsed position to receive a plug element so that a sufficient seal can be established between upper surface 55 and a plug element (not shown). As shown in FIGS. 3A and 3B, first end profile 53 and second end profile 54 are shaped so that they contact and overlap one another when helically-shaped seat member 50 is in the collapsed position (FIGS. 3A and 3B). And, in the embodiments shown in the Figures, first end profile 53 and second end profile 54 have shapes that are reciprocal to each other.

As illustrated in FIGS. 3A and 3B, the collapsed position of helically-shaped seat member 50 of this particular embodiment comprises first end 51 and second end 52 overlapping and in contact with each other to provide a first or collapsed diameter opening 101 (FIG. 3B). In the collapsed position, a plug element such as a ball can be landed on upper surface 55 of helically-shaped seat member 50 to facilitate blocking fluid flow through helically-shaped seat member 50. It is to be understood, however, that a complete seal of fluid flow through helically-shaped seat member 50 is not required as downhole operations such as actuation of downhole tools can be accomplished without attaining a complete leak-proof seal.

As shown in FIGS. 4A and 4B, the expanded position of helically-shaped seat member 50 comprises second end 52 being moved downward away from first end 51 in the direction of arrow 58, and radially outward from first end 51 in the direction of arrow 59 (FIG. 4B) to provide a second or expanded diameter opening 102 (FIG. 4B). In the expanded position, a plug element such as a ball can pass through, either due gravity or with the assistance of pressure acting downward on the plug element so that fluid flow can be reestablished through helically-shaped seat member 50.

Helically-shaped seat member 50 may be formed out of any material desired or necessary to provide a sufficient seal between a plug element and helically-shaped seat member 50 and to allow helically-shaped seat member 50 to move from its collapsed position to its expanded position and vice-versa. For example, helically-shaped seat member may be formed by polyether ether ketone (PEEK), polytetrafluoroethylene (PTFE), rubber, elastomer, metal, reinforced metal, or a combination of any of these materials.

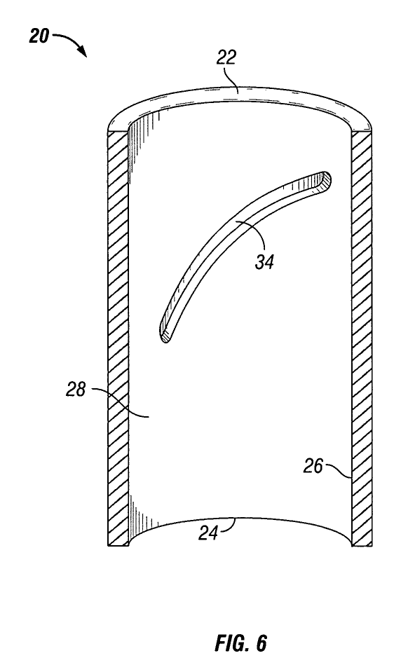

In the particular embodiment of FIGS. 1-6, inner wall surface 26 comprises retaining ring recess 32, sleeve recess or groove 34 (shown in greater detail in FIG. 6), and shoulder 36. Retainer ring 40 is disposed in retaining ring recess 32 and first end of helically-shaped seat member 50 is secured to retainer ring 40.

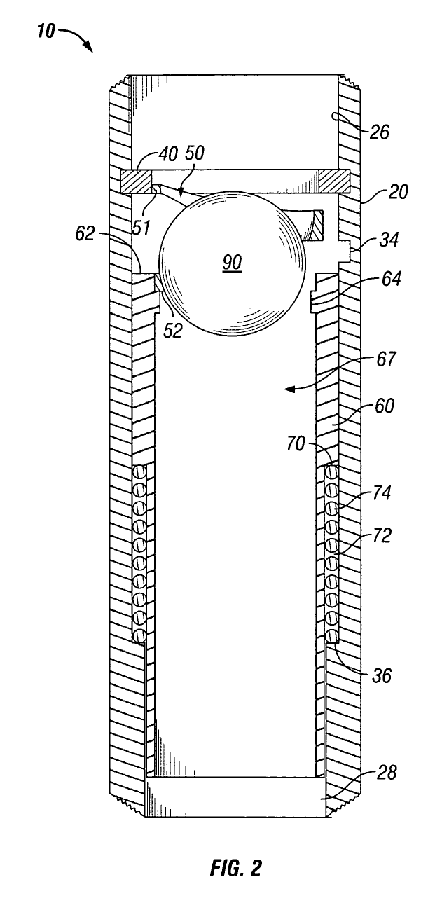

Sleeve 60 is disposed in bore 28 in sliding engagement with inner wall surface 26. Sleeve 60 comprises upper end 62, lower end 63, inner shoulder 64 disposed on inner wall surface 66 which defines sleeve bore 67, pin 68 disposed on the outer wall surface of sleeve 60, and shoulder 70. Second end 52 of helically-shaped seat member 50 is secured to inner shoulder 64 at upper end 62 of sleeve 60 and pin 68 is disposed within sleeve grove 34. When disposed in bore 28, shoulder 70 of sleeve 60, shoulder 36 of housing 20, inner wall surface 26, and the outer wall surface of sleeve 60 provide return member chamber 72. Return member chamber 72 provides upward force to move sleeve 60 upward, and, therefore, move helically-shaped seat member 50 toward its collapsed position (FIGS. 1 and 3). Return member chamber 72 may include any energizing device, structure or method, including being an atmospheric chamber. As shown in FIGS. 1-2, return member chamber 72 includes a return member that is shown as coiled spring 74.

Sleeve groove 34 has a spiral shape as shown in FIG. 6 and pin 68 is at the top of sleeve groove 34 as shown in FIG. 1. The shape of sleeve groove 34 causes sleeve 60 to rotate when sleeve 60 is moved downward because pin 68 forces the rotation as it is moved downward along sleeve groove 34. The rotation of sleeve 60 facilitates radial movement of second end 52 away from first end 51 when a plug element is landed on upper surface 55 of helically-shaped seat member 50 and fluid pressure is increased above the plug element. Although, pin 68 and sleeve groove 34 provide rotation of sleeve 60, it is to be understood that ball seat 10 does not require either pin 68 or sleeve groove 34 to rotate. In another embodiment, pin 68 and sleeve groove 34 are absent and retainer ring 40 is permitted to rotate. In this alternative embodiment, during downward movement of second end 52, first end 51 is rotated to provide second diameter opening 102.

In operation of the embodiment of FIGS. 1-6, ball seat 10 shown in FIG. 1 is secured to a work string and lowered into the wellbore of a well. The position of the components of ball seat 10 shown in FIG. 1 is referred to as the run-in position. A downhole tool (not shown) is disposed in the work string above ball seat 10. Once the downhole tool is in position, and helically-shaped seat member 50 is in the collapsed position, a plug element such as ball 90 (shown in FIG. 2) is dropped down the bore of the work string, through the downhole tool, and landed on upper surface 55 of helically-shaped seat member 50. Fluid, such as hydraulic fluid, is pumped down the work string causing downward force or pressure to act on ball 90. The fluid pressure is then increased above ball 90 until it reaches the actuation pressure of the downhole tool causing the downhole tool to perform its intended function, e.g., set a packer, set a bridge plug and the like. This actuation pressure is a preset pressure that is below the pressure at which the helically-shaped seat member 50 reaches its expanded position.

After the downhole tool has performed its intended function, additional fluid pressure can be exerted on the plug member to force the plug member further into helically-shaped seat member 50 so that helically-shaped seat member 50 is moved to its expanded position (FIG. 2). When helically-shaped seat member 50 reaches its expanded position, the diameter of helically-shaped seat member 50 is increased to the second diameter opening 102 which facilitates passage of ball 90 through helically-shaped seat member 50 as shown in FIG. 2.

As noted above, to facilitate movement of helically-shaped seat member 50 from the collapsed position to the expanded position, sleeve 60 can be rotated or retainer ring 40 can be rotated.

During movement of helically-shaped seat member 50 from the collapsed position to the expanded position through movement of sleeve 60 downward, retaining member 72 is energized such that after ball 90 passes through helically-shaped seat member 50, sleeve 60 is pushed upward causing helically-shaped seat member 50 to move from its expanded position back to its collapsed position. To facilitate movement of helically-shaped seat member 50 from the expanded position to the collapsed position, fluid pressure can be reduced so that sleeve 60 can more easily move upward. As a result of ball 90 being passed through helically-shaped seat member 50 and helically-shaped seat member 50 being returned to its collapsed position, ball seat 10 can be reused to actuate additional downhole tools present in the work string.

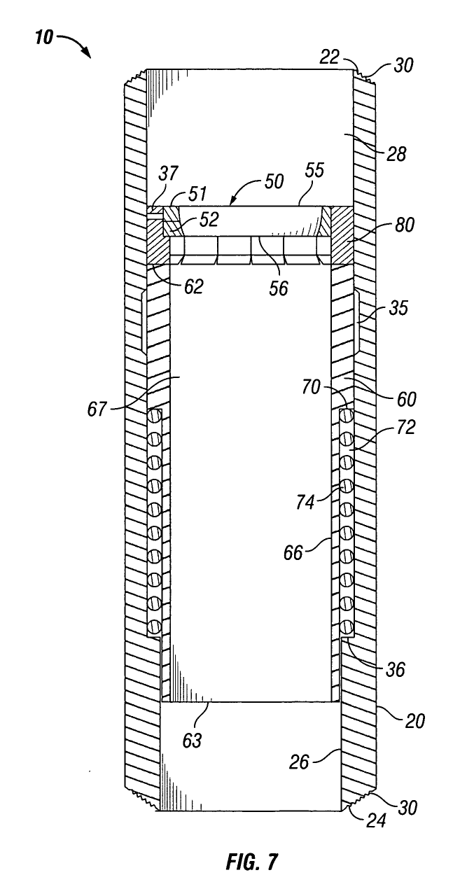

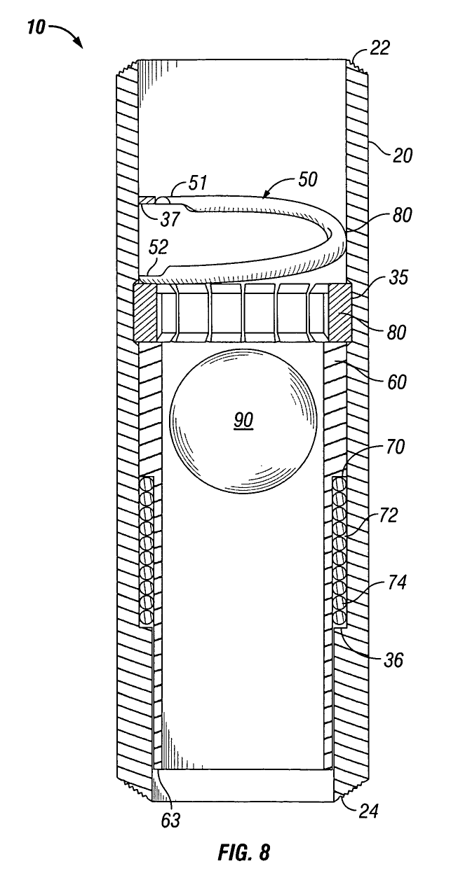

Referring now to FIGS. 7-8, in another embodiment, ball seat 10 comprises expandable member 80 which is shown in FIGS. 7-8 as a set of dogs. Expandable member 80 is operatively associated with sleeve 60 such as being attached to sleeve 60 or, in the case of the dogs shown in FIGS. 7-8, sleeve 60 includes openings at upper end 62 through which each individual dog is inserted. Inner wall surface 26 of housing 20 comprises expandable member recess 35 for receiving expandable member 80. In operation of this embodiment, the plug element, which is shown as ball 90, is landed on upper surface 55 of helically-shaped seat member 50. As fluid pressure builds up above ball 90, expandable member 80 and sleeve 60 are moved downward. In so doing, second end 52 of helically-shaped seat member 50, which is secured to expandable member 80, is moved downward away from first end 51, which is secured to inner wall surface 26 such as through shoulder 37. When expandable member 80 reaches recess 35, expandable member 80 expands radially outward relative to first end 51 and, thus increases its own diameter. This radial expansion of expandable member 80 causes second end 52 to likewise move radially outward to provide second diameter opening 102. As a result, ball 90 can pass through helically-shaped seat member 50 as shown in FIG. 8.

The embodiment of FIGS. 7-8 operates similarly to the embodiment of FIGS. 1-2. Ball seat 10 is first secured to a work string and lowered into the wellbore of a well with a downhole tool (not shown) disposed in the work string above ball seat 10. Once the downhole tool is in position, a plug element such as ball 90 as shown in FIG. 8, is dropped down the bore of the work string, through the downhole tool, and landed on upper surface 55 of helically-shaped seat member 50. Pressure is then increased above the plug element until it reaches the actuation pressure of the downhole tool causing the downhole tool to perform its intended function, e.g., set a packer, set a bridge plug and the like.

After the downhole tool has performed its intended function, additional pressure can be exerted on ball 90 to force ball 90 further into helically-shaped seat member 50 so that helically-shaped seat member 50 is moved to its expanded position (FIG. 8). When expandable member 80 reaches recess 35, expandable member 80 radially expands moving helically-shaped seat member 50 to its expanded position so that the diameter of helically-shaped seat member 50 is increased to the second diameter opening 102 to facilitate passage of ball 90 through helically-shaped seat member 50 as shown in FIG. 8.

Like the embodiment of FIGS. 1-2, when helically-shaped seat member 50 is in the expanded position, such as through movement of expandable member 80 and sleeve 60 downward, retaining member 72 is energized such that after plug element 90 passes through helically-shaped seat member 50, expandable member 80 and sleeve 60 are pushed upward causing helically-shaped seat member 50 to move from its expanded position to its collapsed position. As a result, ball seat 10 can be reused to actuate additional downhole tools present in the work string.

In other embodiments, two ball seats as disclosed are disposed in series within a tubular member. In one such embodiment, the ball seats are disposed in the same housing, with a first ball seat being disposed below a second ball seat. Alternatively, two separate ball seat subs can be connected directly to each other. In this arrangement, the second ball seat is “mirrors” the first ball seat so that pressure being exerted in a upward direction forces the ball into the second helically-shaped seat member and pressure being exerted in downward direction forces the ball into the first helically-shaped seat member. In this arrangement, the two ball seats and their respective helically-shaped seat members function as a valve. In addition, increased force in either direction can move the helically-shaped seat members from their collapsed positions to their expanded position. Moreover, the two ball seats can be operated, i.e., manipulated so that the two helically-shaped seat members operates independently from each other.

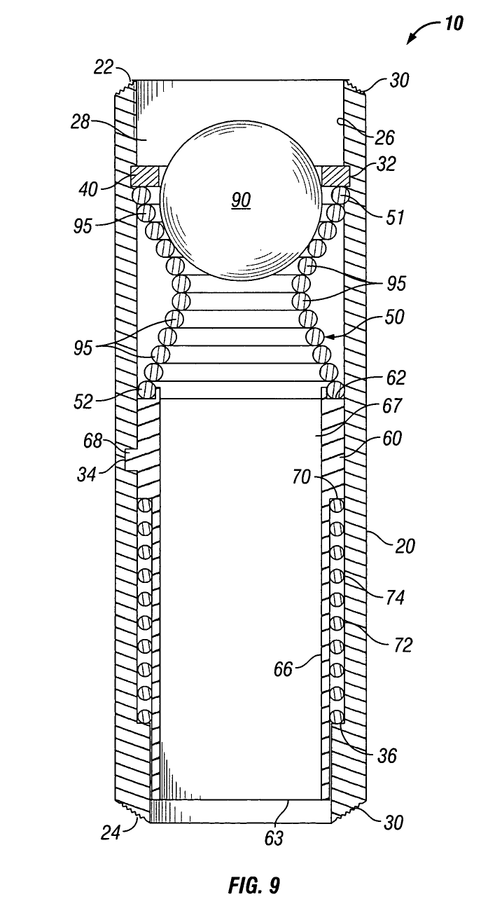

Referring now to FIGS. 9-12, ball seat 10 comprises helically-shaped seat member 50 which comprises a plurality of coils 95 providing an hour-glass shaped cross-section. For example, helically-shaped seat member 50 may comprise a torsion spring.

Helically-shaped seat member 50 is operatively associated with retainer ring 40 and sleeve 60. For example, as shown in FIGS. 9-12, first end 51 is operatively associated with retainer ring 40 and second end 52 is operatively associated with upper end 62 of sleeve 60.

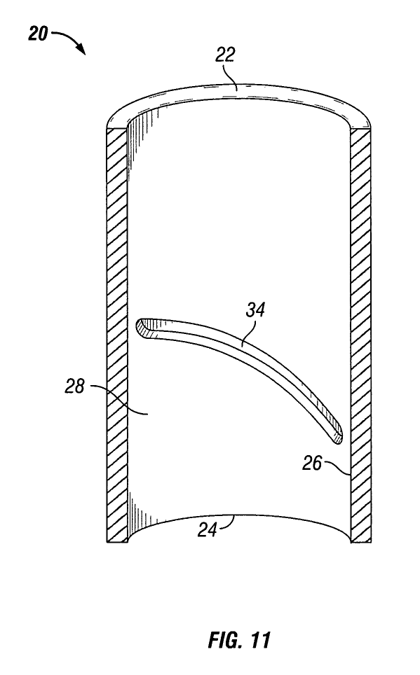

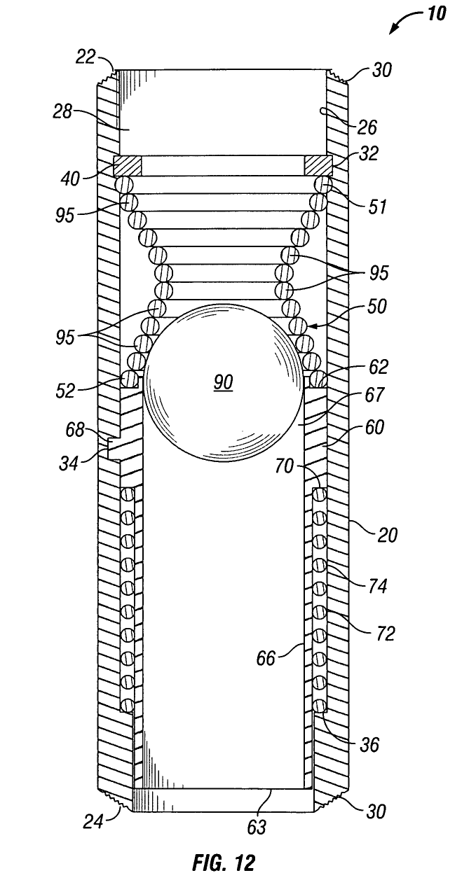

Similar to the embodiment of FIGS. 1-2, sleeve 60 comprises lower end 63, inner wall surface 66, bore 67, pin 68, and shoulder 70; and housing 20 comprises upper end 22, lower end 24, inner wall surface 26, bore 28, threads 30, shoulder 36, recess 32 for receiving retainer ring 40, and groove 34 for receiving pin 68 (shown in greater detail in FIG. 11). And, as with the embodiment of FIGS. 1-6, when disposed in bore 28, shoulder 70 of sleeve 60, shoulder 36 of housing 20, inner wall surface 26, and the outer wall surface of sleeve 60 provide return member chamber 72. Return member chamber 72 provides upward force to move sleeve 60 upward, and, therefore, move helically-shaped seat member 50 toward its collapsed position (FIGS. 9 and 12). Return member chamber 72 may include any energizing device, structure or method, including being an atmospheric chamber. As shown in FIGS. 9-10 and 12, return member chamber 72 includes a return member that is shown as coiled spring 74.

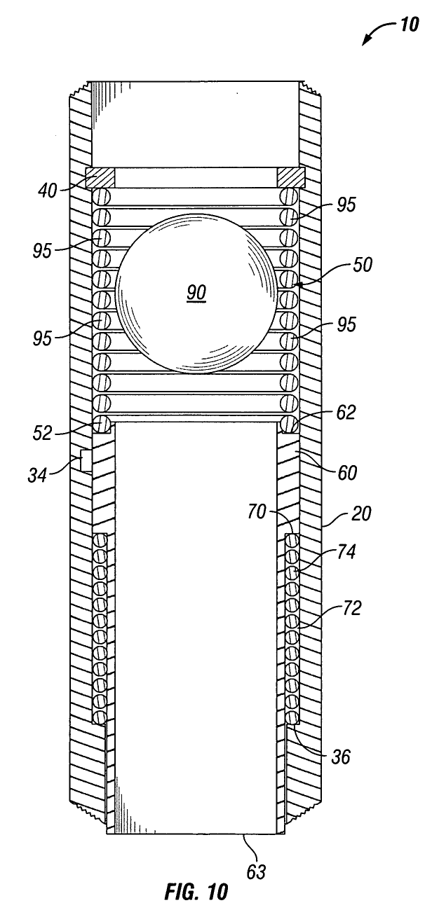

Although sleeve groove 34 has a spiral shape as shown in FIG. 11 which causes sleeve 60 to rotate when sleeve 60 is moved downward because pin 68 forces the rotation as it is moved downward along sleeve groove 34, it is to be understood that groove 34 is not required to have a spiral shape. Instead, groove 34 may be perpendicular to the vertical axis of ball seat 10 such that rotation of sleeve 60, without any axial movement, causes helically-shaped seat member 50 to move from its collapsed position (FIGS. 9 and 12) to its expanded position (FIG. 10).

Rotation of sleeve 60 facilitates radial movement of one or more of coils 95 outward, e.g., toward inner wall surface 26. Such radial movement can be performed using pressure, such as when a plug element is landed on one or more coils 95 of helically-shaped seat member 50 and fluid pressure is increased above the plug element, or through the rotation of sleeve 60 and/or retainer ring 40, such as through mechanical manipulation using hydraulic or electrical lines operatively associated with sleeve 60 and/or retainer ring 40. Further, it is to be understood that ball seat 10 does not require either pin 68 or sleeve groove 34 to facilitate rotation of sleeve 60. It also is to be understood that in certain embodiments, both sleeve and retainer ring 40 rotate. In still other embodiments, either retainer ring 40 or sleeve 60 alone rotates to move helically-shaped seat member from its collapsed position to its expanded position.

The embodiment of FIGS. 9-12 operates similarly to the embodiment of FIGS. 1-2. Ball seat 10 is first secured to a work string and lowered into the wellbore of a well with a downhole tool (not shown) disposed in the work string above ball seat 10. During run-in, helically-shaped seat member 50 can either be disposed in its collapsed position (FIGS. 9 and 12) or its expanded position (FIG. 10). After the downhole tool is in position, and helically-shaped seat member 50 is in the collapsed position, a plug element such as ball 90 as shown in FIGS. 9-10 and 12, can be dropped down the bore of the work string, through the downhole tool, and landed on one or more coils 95 of helically-shaped seat member 50. If helically-shaped seat member 50 was initially disposed in the wellbore while in the expanded position, helically-shaped seat member 50 is first moved from its expanded position to its collapsed position, such as by shearing a shear screw (not shown) maintaining helically-shaped seat member 50 in its expanded position, or through mechanical manipulation using hydraulic or electrical lines (not shown), or through any other method or device known to persons of ordinary skill in the art.

After ball 90 is landed on helically-shaped seat member 50, pressure is increased above the plug element until it reaches the actuation pressure of the downhole tool causing the downhole tool to perform its intended function, e.g., set a packer, set a bridge plug and the like. Subsequently, additional pressure can be exerted on ball 90 to force ball 90 further into helically-shaped seat member 50 to facilitate movement of helically-shaped seat member 50 to its expanded position (FIG. 10). In addition, sleeve 60 and/or retainer ring 40 can be rotated to facilitate movement of helically-shaped seat member 50 to its expanded position (FIG. 10). Moving helically-shaped seat member 50 to its expanded position causes that the diameter of helically-shaped seat member 50 to be increased to the second diameter opening to facilitate passage of ball 90 through helically-shaped seat member 50 as shown in FIG. 10.

Like the embodiment of FIGS. 1-6, when helically-shaped seat member 50 is in the expanded position, retaining member 72 is energized such that after plug element 90 passes through helically-shaped seat member 50, sleeve 60 is pushed upward causing helically-shaped seat member 50 to move from its expanded position to its collapsed position. Thereafter, or during, fluid pressure from above ball seat 10 can be reduced, allowing ball 90 to either float up, or to be pushed upward due to the fluid pressure being higher below ball 90 than above ball 90, causing ball 90 to be pushed into coils 95 of helically-shaped seat member as illustrated in FIG. 12. As a result, ball 90 blocks upward fluid flow through ball seat 10. Thus, ball seat 10 operates as a valve that is capable of restricting fluid flow in both the upward direction as well as the downward direction.

In other embodiments of the ball seats disclosed herein, mechanisms that limit the number of times the helically-shaped seat members move from the collapsed position to the expanded position can be included in the work string. For example, multiple tools and multiple ball seats are disposed along the length of the work string. A first ball is then dropped down the work string where it lands on a first helically-shaped seat member which is moved from its collapsed position to its expanded position and the ball is dropped to a second ball seat. In so doing, the counter mechanism records that the first ball seat was “opened.” This procedure continues until the first ball reaches a ball seat that is set to “zero,” meaning the helically-shaped seat member will not “open” to its expanded position. A downhole operation is then performed based on the first ball landing on the lowermost ball seat.

A second ball is then dropped and the procedure is repeated. This time, however, the ball continues to fall until it reaches a ball seat above the lowermost ball seat. This ball seat was originally set by the counter mechanism to “1,” however, the counter mechanism is now set at “zero,” due to the passage of the first ball to the lowermost ball seat. As a result, the second ball lands on the ball seat above the lowermost ball seat and a second downhole operation is performed.

This procedure repeats itself until all of the counter mechanisms associated with the ball seats reach “zero” and all downhole operations have been completed. Thereafter, the counter mechanisms can be reset and downward fluid pressure can force all of the balls through all of the ball seats and out of the bottom of the work string so that the work string can be moved to a new zone and the entire procedure repeated.

It is to be understood that the invention is not limited to the exact details of construction, operation, exact materials, or embodiments shown and described, as modifications and equivalents will be apparent to one skilled in the art. For example, return member can comprise a coiled spring, belleville spring (also known as belleville washers), a spiral spring, an elastomeric material, or the like. Further, the size of first and second diameter openings can be modified as necessary or desired based upon the size of the plug element. In addition, the first and second ends do not have to contact or otherwise engage one another when the helically-shaped seat member is in its collapsed position. Moreover, devices other than the sleeve and return member disclosed herein can be used to facilitate movement of the helically-shaped seat member from the collapsed position to the expanded position and vice-versa.

Additionally, although the apparatuses described in greater detail with respect to FIGS. 1-8 are ball seats having a ball as their respective plug elements, it is to be understood that the apparatuses disclosed herein may be any type of seat known to persons of ordinary skill in the art that include a helically-shaped seat member. For example, the apparatus may be a drop plug seat, wherein the drop plug temporarily restricts the flow of fluid through the wellbore. Therefore, the term “plug” as used herein encompasses a ball as shown in FIGS. 2 and 8, as well as any other type of device that is used to restrict the flow of fluid through a ball seat. Further, in all of the embodiments discussed with respect to FIGS. 1-8, upward, toward the surface of the well (not shown), is toward the top of FIGS. 1-8, and downward or downhole (the direction going away from the surface of the well) is toward the bottom of FIGS. 1-8. However, it is to be understood that the ball seats may have their positions rotated. Moreover, the helically-shaped seat member can be disposed either in its collapsed position or its expanded position during run-in of the ball seat. And, movement of the helically-shaped seat member to and from its collapsed position to and from its expanded position can be performed by one or more of rotation movement of the helically-shaped seat member, axial movement of the helically-shaped seat member, or any other method or device known to persons of ordinary skill in the art. Accordingly, the ball seats can be used in any number of orientations easily determinable and adaptable to persons of ordinary skill in the art. Accordingly, the invention is therefore to be limited only by the scope of the appended claims.

What is claimed is:

1. A ball seat comprising:
a tubular member having an inner wall surface defining a tubular bore; and
a helically-shaped seat member for receiving a ball, the helically-shaped seat member being disposed within the bore of the tubular,
wherein the helically-shaped seat member comprises first and second ends, a first position in which the first and second ends are disposed relative to each other to provide a first diameter opening through the helically-shaped seat member for receiving the ball, and a second position in which the second end is disposed radially outward relative to the first end to provide a second diameter opening through the helically-shaped seat member, the second diameter being greater than the first diameter thereby facilitating the ball to pass through the helically-shaped seat member.

2. The ball seat of claim 1, wherein the first end of the helically-shaped seat member is secured to an inner wall surface of the tubular member.

3. The ball seat of claim 2, wherein the second end of the helically-shaped seat member is secured to a sleeve, the sleeve being in sliding engagement with an inner wall surface of the tubular member.

4. The ball seat of claim 3, further comprising a return member operatively associated with the sleeve for urging the helically-shaped seat member toward the first position.

5. The ball seat of claim 4, wherein the inner wall surface of the tubular comprises a tubular shoulder and the sleeve comprises a sleeve shoulder, the tubular shoulder, the sleeve shoulder, the inner wall surface of the tubular, and an outer wall surface of the sleeve providing a return member chamber, and
wherein the return member is disposed in the return member chamber.

6. The ball seat of claim 5, wherein the return member is a coiled spring.

7. The ball seat of claim 3, wherein the sleeve comprises a pin disposed on an outer wall surface of the sleeve, the pin being operatively associated with a spiral-shaped groove disposed on the inner wall surface of the tubular member such that movement of the sleeve in a downward direction causes the sleeve to rotate about an axis of the ball seat.

8. The ball seat of claim 1, further comprising an expandable member, the expandable member being in sliding contact with the inner wall surface of the tubular member, wherein the second end of the helically-shaped seat member is secured to the expandable member.

9. The ball seat of claim 8, wherein the inner wall surface of the tubular member comprises a recess, the recess operatively associated with the expandable member allowing the expandable member to move to a radially expanded position to facilitate the helically-shaped seat member moving to the second position to provide the second diameter opening.

10. The ball seat of claim 9, wherein the expandable member comprises a set of dogs.

11. The ball seat of claim 1, wherein the first end comprises a first profile disposed along an upper surface of the first end,
the second end comprises a second profile disposed along an upper surface of the second end, the first profile comprises a first profile shape that is reciprocal to a second profile shape of the second profile, and
the first profile mates with the second profile when the helically-shaped seat member is in the first position.

12. The ball seat of claim 1, further comprising a retainer ring disposed along the inner wall surface of the tubular member, the retainer ring being operatively associated with the helically-shaped seat member,
wherein the first end of the helically-shaped seat member is secured to the retainer ring.

13. The ball seat of claim 12, wherein the second end of the helically-shaped seat member is secured to an upper end of the sleeve, the sleeve being in sliding engagement with the inner wall surface of the tubular member.

14. The ball seat of claim 13, wherein the retainer ring rotates within a recess disposed on the inner wall surface of the tubular.

15. The ball seat of claim 1, wherein the second end is disposed axially below relative to the first end to provide the second diameter opening through the helically-shaped seat member when the helically-shaped seat member is in its second position.

16. An apparatus for restricting flow through a well conduit, the apparatus comprising:
a housing having a longitudinal bore having an axis and a first seat disposed within the bore, the first seat comprising
a first helically-shaped seat member, the first helically-shaped seat member having a first position defining a first diameter opening and a second position defining a second diameter opening, the second diameter opening being larger than the first diameter opening,
a first sleeve disposed in the bore, the first sleeve being in sliding engagement with an inner wall surface of the housing and being operatively associated with the first helically-shaped seat member, and
a first return member operatively associated with the first sleeve for urging the first helically-shaped seat member toward its first position; and
a plug element adapted to be disposed into the bore and landed on the first helically-shaped seat member when in its first position to restrict fluid flow through the bore and the well conduit and to facilitate movement of the first helically-shaped seat member from its first position to its second position thereby facilitating the plug element to pass through the first helically-shaped seat member facilitating movement of the first helically-shaped seat member from its second position to its first position by the return member.

17. The apparatus of claim 16, wherein a first end of the first helically-shaped seat member is secured to an inner wall surface of the bore and a second end of the first helically-shaped seat member is secured to an upper end of the first sleeve.

18. The apparatus of claim 17, wherein the first end comprises a first profile disposed along an upper surface of the first end,
the second end comprises a second profile disposed along an upper surface of the second end, and
wherein the first profile comprises a first profile shape that is reciprocal to a second profile shape of the second profile so that the first profile mates with the second profile when the first helically-shaped seat member is in the first position.

19. The apparatus of claim 16, wherein the first helically-shaped seat member comprises a plurality of coils providing an hour-glass cross-section when the helically-shaped seat member is disposed in its first position.

20. The apparatus of claim 16, further comprising a second seat disposed in the bore above the first seat, the second seat comprising
a second helically-shaped seat member, the second helically-shaped seat member having a first position defining a first diameter opening and a second position defining a second diameter opening, the second diameter opening being larger than the first diameter opening,
a second sleeve disposed in the bore, the second sleeve being in sliding engagement with the inner wall surface of the housing and being operatively associated with the second helically-shaped seat member, and
a second return member operatively associated with the second sleeve for urging the second helically-shaped seat member toward its first position,
wherein the plug element is adapted to be landed on the second helically-shaped seat member when in its first position to restrict fluid flow through the bore and the well conduit and to facilitate movement of the second helically-shaped seat member from its first position to its second position thereby facilitating the plug element to pass through the second helically-shaped seat member facilitating movement of the second helically-shaped seat member from its second position to its first position by the return member, and
wherein the plug element is disposed between the first seat and the second seat so that downward pressure forces the plug element into the first seat and upward pressure forces the plug element into the second seat.

21. A method of temporarily restricting a well conduit, the method comprising the steps of:
(a) providing a seat disposed within a housing having a longitudinal bore, the seat comprising
a helically-shaped seat member having a first position defining a first diameter opening and a second position defining a second diameter opening, the second diameter opening being larger than the first diameter opening, the second position defined by movement of at least one coil of the helically-shaped seat member radially outward;
(b) lowering the seat on a string of conduit into a wellbore of a well;
(c) restricting the bore and well conduit by inserting a plug element into the conduit and landing the plug element on the helically-shaped seat member when the helically-shaped seat member is in the first position;
(d) moving the helically-shaped seat member from the first position to the second position to provide the second diameter opening; and
(e) continuing to exert a force on the plug element facilitating passing the plug element through the second diameter opening of the helically-shaped seat member.

22. The method of claim 21, further comprising the step of:
(f) moving the sleeve upward by the return member causing the helically-shaped seat member to move from the second position to the first position, and
wherein steps (c)-(e) are repeated.

23. The method of claim 21, wherein step (d) is performed by rotating the helically-shaped seat member.

24. The method of claim 23, wherein step (d) is performed by axially moving an end of the helically-shaped seat member.

25. The method of claim 21, wherein a downhole tool is actuated as a result of pumping fluid into the conduit forcing the plug element into the helically-shaped seat member and energizing the return member.
